(19) United States
(12) Patent Application Publication
(10) Pub. No.: US 2014/0323659 A1
(43) Pub. Date: Oct. 30, 2014

(54) METHOD FOR PRODUCING RESIN COMPOSITION AND RESIN COMPOSITION

(71) Applicant: CANON KABUSHIKI KAISHA, Tokyo (JP)

(72) Inventors: Taku Shimoda, Machida-shi (JP); Keiichiro Tsubaki, Tokyo (JP); Takayuki Hiratani, Tokyo (JP); Akira Kuriyama, Atsugi-shi (JP); Kazumichi Nakahama, Tokyo (JP)

(73) Assignee: CANON KABUSHIKI KAISHA, Tokyo (JP)

(21) Appl. No.: 14/261,304

(22) Filed: Apr. 24, 2014

(30) Foreign Application Priority Data
Apr. 26, 2013 (JP) 2013-093538

(51) Int. Cl. C08L 33/26; C08L 33/12; C08L 25/06

(52) U.S. Cl. CPC C08L 33/26; C08L 25/06; C08L 33/12
USPC 525/218

(57) ABSTRACT

A method for producing a resin composition, comprising the step of: subjecting a radical copolymerization of a first radical polymerizable monomer which is free from any crystalline molecular chain, and a second radical polymerizable monomer having a crystalline molecular chain, in the presence of a radical polymerization initiator, wherein the second radical polymerizable monomer is the following compound, and

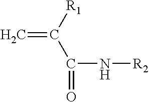

(wherein R₁ denotes a hydrogen atom or a methyl group, and R₂ denotes an alkyl group having at least 17 carbon atoms) the first radical polymerizable monomer has a particular reactivity ratio.

### BACKGROUND OF THE INVENTION

1. Field of the Invention

The present invention relates to a method for producing a resin composition and a resin composition.

2. Description of the Related Art

Viscoelasticity is the property of materials that exhibit time-dependent strain upon the application of stress to the materials and return close to their original state with residual strain once the stress is removed. Resin compositions are used in various industrial sectors. Resin compositions suitable for resin binders for ink jet inks and electrophotography toners have a property of rapidly changing their viscoelasticity with an increase in temperature (hereinafter referred to as a “sharp melt property”) so as to satisfy both storage stability and image forming capability.

Crystalline polymers, such as polymers of a radical polymerizable monomer having a crystalline molecular chain and polyesters having a crystalline main chain, have the sharp melt property. Because of their significant low-temperature brittleness, however, crystalline polymers are difficult to use alone.

Low-temperature brittleness characteristic of crystalline polymers is ameliorated in resin compositions containing both a crystalline polymer and an amorphous polymer as described in Japanese Patent Laid-Open No. 2012-88580.

A method for producing a resin composition according to Japanese Patent Laid-Open No. 2012-88580 involves at least a crystalline polymer synthesis process, an amorphous polymer synthesis process, and a process of mixing the crystalline polymer with the amorphous polymer. Such many production processes are not preferred in terms of environmental load.

Thus, there is a demand for a method for producing a resin composition that has a sharp melt property and has toughness at room temperature in a single production process.

### SUMMARY OF THE INVENTION

The present invention provides a method for producing a resin composition, comprising the step of: subjecting a radical copolymerization of

a first radical polymerizable monomer which is free from any crystalline molecular chain, and

a second radical polymerizable monomer having a crystalline molecular chain, in the presence of a radical polymerization initiator,

wherein the second radical polymerizable monomer is the following compound 1,

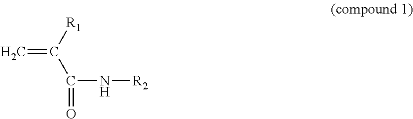

(wherein R₁ denotes a hydrogen atom or a methyl group, and R₂ denotes an alkyl group having at least 17 carbon atoms) the first radical polymerizable monomer and the second radical polymerizable monomer are a combination of monomers such that a precipitate, which is obtained by a method shown below, has a phase separation structure,
the method comprising the steps of:

preparing a first homopolymer by polymerizing the first radical polymerizable monomer,

preparing a second homopolymer by polymerizing the second radical polymerizable monomer,

dissolving the first homopolymer and the second homopolymer in a solvent and obtaining a solution of the homopolymers, and

adding the solution of the homopolymers to a common poor solvent and obtaining the precipitate,

the first radical polymerizable monomer has the following monomer reactivity ratio r₁, and the second radical polymerizable monomer has the following monomer reactivity ratio r₂, and

r₁>1.0

r₂<1.0

(wherein r₁=k₁₁/k₁₂,
wherein k₁₁ denotes a reaction rate constant of an addition reaction in which the first radical polymerizable monomer binds to the first radical polymerizable monomer, and
k₁₂ denotes a reaction rate constant of an addition reaction in which the second radical polymerizable monomer binds to the first radical polymerizable monomer, and

r₂=k₂₂/k₂₁,

wherein k₂₂ denotes a reaction rate constant of an addition reaction in which the second radical polymerizable monomer binds to the second radical polymerizable monomer, and
k₂₁ denotes a reaction rate constant of an addition reaction in which the first radical polymerizable monomer to the second radical polymerizable monomer)
the ratio (B/(A+B)) of the second radical polymerizable monomer to the first radical polymerizable monomer is 0.25 or more and 0.80 or less in the copolymerization, wherein A denotes the amount of first radical polymerizable monomer (parts by mass), and B denotes the amount of second radical polymerizable monomer (parts by mass).

The present invention also provides a resin composition, comprising a first unit which is free from any crystalline molecular chain and a second unit having a crystalline molecular chain, wherein

the second unit is the following unit 1,

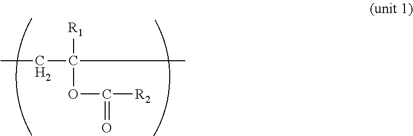

(wherein R₁ denotes a hydrogen atom or a methyl group, and R₂ denotes an alkyl group having at least 17 carbon atoms) the ratio (D/(C+D)) of the second unit to the first unit is 0.25 or more and 0.80 or less in the resin composition, wherein C denotes the amount of first unit (parts by mass), and D denotes the amount of second unit (parts by mass), and the resin composition has a sea-island type phase separation structure in which a main unit of a resin component forming the island phase is the first unit, and a main unit of a resin component forming the sea phase is the second unit.

Further features of the present invention will become apparent from the following description of exemplary embodiments with reference to the attached drawings.

### BRIEF DESCRIPTION OF THE DRAWINGS

FIG. 1 is an explanatory view of the sharp melt property in the present invention.

FIG. 2 is an explanatory view of elementary reactions in a radical copolymerization reaction of a radical polymerizable monomer which is free from any crystalline molecular chain and a radical polymerizable monomer having a crystalline molecular chain.

### DESCRIPTION OF THE EMBODIMENTS

The present invention will be described in detail below.

The present invention relates to a method for producing a resin composition, comprising the step of: subjecting a radical copolymerization of a radical polymerizable monomer which is free from any crystalline molecular chain and a radical polymerizable monomer having a crystalline molecular chain, in the presence of a radical polymerization initiator. A crystalline molecular chain in the present invention is a crystalline side chain and is a side chain bonded to a main chain in a resin composition formed by a radical copolymerization. Hereafter, “the radical polymerizable monomer which is free from any crystalline molecular chain” may be referred to as “the first radical polymerizable monomer”, and “the radical polymerizable monomer having a crystalline molecular chain” may be referred to as “the second radical polymerizable monomer”.

In accordance with the present invention, a resin composition having a sharp melt property and low-temperature toughness can be produced in a single production process.

In a production method according to the present invention, the first radical polymerizable monomer and the second radical polymerizable monomer have the following monomer reactivity ratios.

r₁>1.0

r₂<1.0

The monomer reactivity ratios will be described below.

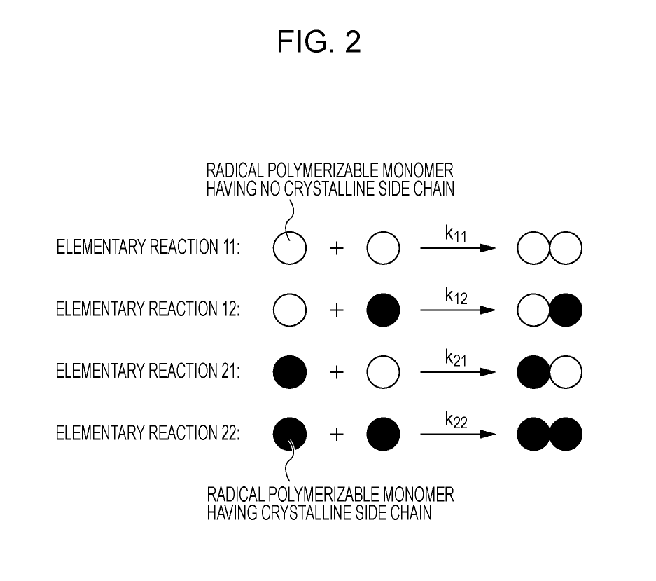

A radical copolymerization of the first radical polymerizable monomer and the second radical polymerizable monomer includes the following four elementary reactions (see FIG. 2).

(1) Elementary reaction 11: The first radical polymerizable monomer binds to the first radical polymerizable monomer.
(2) Elementary reaction 12: The second radical polymerizable monomer binds to the first radical polymerizable monomer.
(3) Elementary reaction 22: The second radical polymerizable monomer binds to the second radical polymerizable monomer.
(4) Elementary reaction 21: The first radical polymerizable monomer binds to the second radical polymerizable monomer.

The monomer reactivity ratio r₁ is expressed by the following equation, wherein k₁₁ denotes the reaction rate constant of the elementary reaction 11, and k₁₂ denotes the reaction rate constant of the elementary reaction 12.

r₁=k₁₁/k₁₂

The monomer reactivity ratio r₂ is expressed by the following equation, wherein k₂₂ denotes the reaction rate constant of the elementary reaction 22, and k₂₁ denotes the reaction rate constant of the elementary reaction 21.

r₂=k₂₂/k₂₁

A radical copolymerization of the first radical polymerizable monomer and the second radical polymerizable monomer having monomer reactivity ratios r₁ and r₂ that satisfy the formulae described above yields a resin composition containing the following copolymers:

(1) a copolymer 1 rich in a first unit which is free from any crystalline molecular chain; and
(2) a copolymer 2 rich in a second unit having a crystalline molecular chain. The present inventors found in an experiment that a resin composition containing the copolymer 1 and the copolymer 2 has a sharp melt property and toughness at room temperature.

On the other hand, a combination of the first radical polymerizable monomer and the second radical polymerizable monomer that do not satisfy the formulae described above results in a random copolymer of a monomer which is free from any crystalline molecular chain and a monomer having a crystalline molecular chain. A resin composition containing such a random copolymer does not have a sharp melt property or does not have a sharp melt property at an intended temperature. This is probably because such a random copolymer of a monomer which is free from any crystalline molecular chain and a monomer having a crystalline molecular chain has a great distance between the crystalline molecular chains, which become side chains of the copolymer, and this inhibits or reduces crystallization.

The monomer reactivity ratios of radical polymerizable monomers are generally found in Polymer Handbook Third Edition (Wiley), II/153-II/266. The monomer reactivity ratios can also be determined using a conventional method, such as a curve fitting method, an intersection point method, a Fineman-Ross method, or a Kelen-Tudos method.

The radical polymerizable monomer having a crystalline molecular chain and the unit having a crystalline molecular chain according to an embodiment of the present invention will be described below.

The radical polymerizable monomer having a crystalline molecular chain according to an embodiment of the present invention is an acrylamide or methacrylamide having the following formula (compound 1).

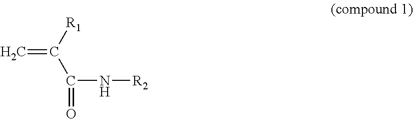

(wherein R₁ denotes a hydrogen atom or a methyl group, and R₂ denotes an alkyl group having at least 17 carbon atoms)

A resin composition according to an embodiment of the present invention contains the compound 1 in the form of the following unit 1.

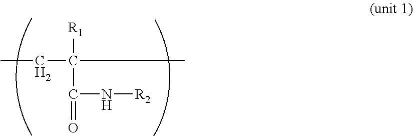

(wherein R₁ denotes a hydrogen atom or a methyl group, and R₂ denotes an alkyl group having at least 17 carbon atoms)

Crystalline polymers have a melting point and have a sharp melt property based on a melting phenomenon at the melting point. The melting point of a crystalline polymer depends on the molecular weight of a crystalline molecular chain of the crystalline polymer.

This means that the temperature at which a resin composition exhibits its sharp melt property depends on the molecular weight of a crystalline molecular chain. The present inventors found that when the number of carbon atoms of R₂ in the compound 1 and the unit 1 is 17 or more (a molecular weight of 239 or more), the crystalline component has an appropriate melting point, and the resin composition exhibits a sharp melt property at an appropriate temperature. R₂ of the compound 1 and the unit 1 composed of a linear alkyl group exhibits higher crystal growth than R₂ composed of a branched alkyl group. The acrylamide(s) and/or methacrylamide(s) may be used alone or in combination.

In general, an alkylacrylamide or an alkylmethacrylamide serving as a radical polymerizable monomer having a crystalline molecular chain can be produced using one of the following two methods.

In one method, an acrylamide or a methacrylamide is allowed to react with a halogenated alkyl in an aprotic polar solvent, such as N,N-dimethylformamide, in the presence of a strong basic substance, such as potassium hydroxide. In the other method, an acrylic acid chloride or a methacrylic acid chloride is allowed to react with an alkylamine.

The first radical polymerizable monomer and the first unit which is free from any crystalline molecular chain will be described below.

A first radical polymerizable monomer is synonymous with an amorphous radical polymerizable monomer. Any radical polymerizable monomer which is free from any crystalline molecular chain that has a reactivity ratio that satisfies the formula described above may be used. For example, the first radical polymerizable monomer is styrene, an amorphous styrene derivative, an amorphous acrylate, or an amorphous methacrylate. A plurality of radical polymerizable monomer which is free from any crystalline molecular chains may be used in combination. A unit which is free from any crystalline molecular chain according to an embodiment of the present invention is derived from the corresponding radical polymerizable monomer which is free from any crystalline molecular chain.

In accordance with an embodiment of the present invention, the first radical polymerizable monomer and the second radical polymerizable monomer are a combination of monomers such that a precipitate, which is obtained by a method shown below, has a phase separation structure,

the method comprising the steps of:

preparing a first homopolymer by polymerizing the first radical polymerizable monomer,

preparing a second homopolymer by polymerizing the second radical polymerizable monomer,

dissolving the first homopolymer and the second homopolymer in a solvent and obtaining a solution of the homopolymers, and

adding the solution of the homopolymers to a common poor solvent and obtaining the precipitate.

As described above, a resin composition according to an embodiment of the present invention contains a copolymer 1 rich in a unit which is free from any crystalline molecular chain and a copolymer 2 rich in a unit having a crystalline molecular chain. Thus, the copolymer 1 and a homopolymer of the first radical polymerizable monomer have very similar thermodynamic properties. The copolymer 2 and a homopolymer of the second radical polymerizable monomer also have very similar thermodynamic properties. Thus, the phase separation between a homopolymer of the first radical polymerizable monomer and a homopolymer of the second radical polymerizable monomer implies phase separation between the copolymer 1 and the copolymer 2.

A phase separation structure of a homopolymer of the first radical polymerizable monomer (hereinafter referred to as a first homopolymer) and a homopolymer of a radical polymerizable monomer having a crystalline molecular chain (hereinafter referred to as a second homopolymer) can be examined as described below.

The phase separation can be examined by drying the resulting precipitate, and observing the inner structure of the resulting resin composition. In the case that the first homopolymer and the second homopolymer are incompatible with each other and undergo phase separation, the inner structure includes a phase separation structure associated with a spinodal phase separation phenomenon or a nucleation-nuclear growth phase separation phenomenon. In the case that the homopolymer 1 and the homopolymer 2 are compatible with each other, no clear phase separation structure is observed in the inner structure. Examples of the phase separation structure include a sea-island type structure, a cylinder structure, a lamellar structure, and a bicontinuous structure. A resin composition according to an embodiment of the present invention may contain copolymers that form a sea-island type phase separation structure. When the main unit of a resin component forming the island phase is a unit which is free from any crystalline molecular chain, and the main unit of a resin component forming the sea phase is a unit having a crystalline molecular chain, the resin composition can have a sharp melt property.

The inner structure of a resin composition can be examined by observing a cross section of the resin composition using a conventional method, for example, with a transmission electron microscope or a scanning probe microscope.

In accordance with an embodiment of the present invention, the ratio (B/(A+B)) of the second radical polymerizable monomer to the first radical polymerizable monomer is 0.25 or more and 0.80 or less in the copolymerization, wherein A denotes the amount of first radical polymerizable monomer which is free from any crystalline molecular chain (parts by mass), and B denotes the amount of second radical polymerizable monomer (parts by mass).

A ratio (B/(A+B)) of less than 0.25 results in a polymerization composition having an insufficient sharp melt property. A ratio (B/(A+B)) of more than 0.80 results in marked brittleness at room temperature. In accordance with an embodiment of the present invention, the ratio (B/(A+B)) may be 0.30 or more and 0.60 or less.

The present inventors found in an experiment that a ratio (B/(A+B)) of 0.30 or more results in a stable excellent sharp melt property independent of the mass of a unit having a crystalline molecular chain contained in the resin composition. The present inventors also found in an experiment that a ratio (B/(A+B)) of 0.60 or less results in particularly good toughness at room temperature.

When the first radical polymerizable monomer and the second radical polymerizable monomer that satisfy the ratio (B/(A+B)) described above are used, the ratio (D/(C+D)) of the unit having a crystalline molecular chain to the unit which is free from any crystalline molecular chain in the resulting resin composition is 0.25 or more and 0.80 or less, wherein C denotes the amount of unit which is free from any crystalline molecular chain (parts by mass), and D denotes the amount of unit having a crystalline molecular chain (parts by mass).

The ratio (D/(C+D)) may be 0.30 or more and 0.60 or less.

A conventionally known radical polymerization initiator may be used in the polymerization of the first radical polymerizable monomer and the second radical polymerizable monomer. Examples of the radical polymerization initiator include azo polymerization initiators, such as 2,2′-azobisisobutyronitrile, 2,2′-azobis-(2-methylpropanenitrile), 2,2′-azobis-(2,4-dimethylpentanenitrile), 2,2′-azobis-(2-methylbutanenitrile), 1,1′-azobis-(cyclohexanecarbonitrile), 2,2′-azobis-(2,4-dimethyl-4-methoxyvaleronitrile), and 2,2′-azobis-(2,4-dimethylvaleronitrile), and organic peroxide polymerization initiators, such as dibenzoyl peroxide, cumene hydroperoxide, di-2-ethylhexyl peroxydicarbonate, di-sec-butyl peroxydicarbonate, acetyl peroxide, and peresters (for example, t-butyl peroctoate, α-cumyl peroxypivalate, and t-butyl peroctoate). Acetophenone or ketal photo radical polymerization initiators may also be used. These radical polymerization initiators may be used alone or in combination. In the case that two or more radical polymerization initiators are used, use of radical polymerization initiators having different 10-hour half-life temperatures that differ by 10° C. or more tends to increase the polymerization conversion of a radical copolymerization.

A radical copolymerization according to an embodiment of the present invention may be induced using a general method for inducing a radical polymerization, such as heating, photoirradiation, or the addition of a reducing agent. Heating has good workability or chemical reaction controllability. When radical growth is induced by heating, the heating temperature is preferably greater than or equal to the 10-hour half-life temperature of at least one radical polymerization initiator and less than or equal to the 10-hour half-life temperature +30° C. More preferably, the heating temperature is greater than or equal to the 10-hour half-life temperature and less than or equal to the 10-hour half-life temperature +20° C. The heating temperature in a polymerization process according to an embodiment of the present invention may be increased or decreased. A radical copolymerization may be performed after a polymerizable monomer composition containing a radical polymerizable monomer which is free from any crystalline molecular chain, a radical polymerizable monomer having a crystalline molecular chain, and a radical polymerization initiator is prepared. A radical polymerization initiator may be further added to the reaction system during the radical copolymerization. In a polymerization process according to an embodiment of the present invention, the reaction system may be in an atmosphere of an inert gas, such as argon gas or nitrogen gas.

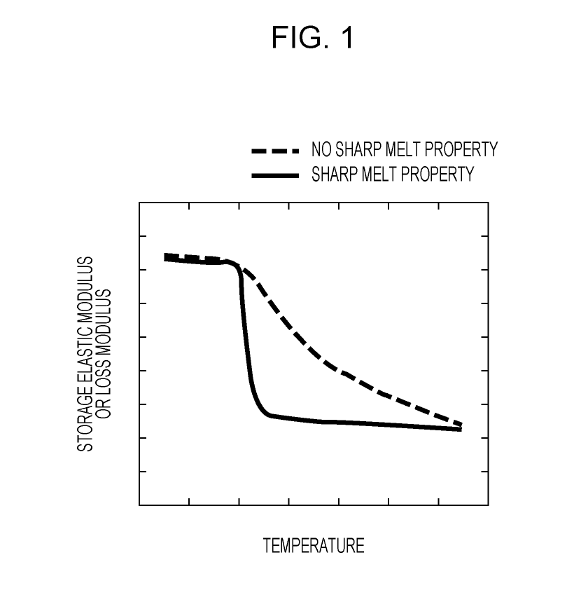

The term “sharp melt property”, as used herein, means that the storage elastic modulus or loss modulus changes rapidly with temperature, as illustrated in FIG. 1. The viscoelasticity of a resin composition may be measured using a conventional method, such as with a rheometer.

### EXAMPLES

A method for producing a resin composition according to the present invention will be further described in the following examples. The present invention is not limited to these examples.

### (Measurement of Resin Viscoelasticity)

A resin composition was pelletized at 4 MPa. The loss modulus of the pellets was measured as a function of temperature with a rheometer AR 2000ex (manufactured by TA Instruments).

The temperature at which a homopolymer of a radical polymerizable monomer having a crystalline molecular chain exhibits its sharp melt property was taken as a reference temperature. In the case that the variation width of loss modulus between the reference temperature +5° C. and the reference temperature −5° C. was 10⁷ Pa or more, the sample was judged to have a sharp melt property.

### (Method for Observing Phase Separation Structure)

A cured product of resin particles embedded in an epoxy resin was cut with a microtome having a diamond knife to prepare a sample slice. The sample slice was stained with ruthenium tetroxide. The phase separation structure was examined by observing a cross section of a resin particle with a transmission electron microscope (H7500 manufactured by Hitachi, Ltd.).

### (Evaluation of Brittleness)

Brittleness was evaluated by comparing friability between an acrylamide or methacrylamide homopolymer having a crystalline molecular chain and a resin composition synthesized using an acrylamide or methacrylamide having a crystalline molecular chain as a radical polymerizable monomer.

More specifically, the homopolymer and the resin composition were pelletized at 4 MPa. The friability of pellets was compared for the homopolymer and the resin composition by crushing the pellets with fingers at room temperature.

A resin composition having substantially the same friability as the homopolymer was rated as being poor. A resin composition less friable than the homopolymer was rated as being fair. A resin composition much less friable than the homopolymer was rated as being good.

### (Synthesis Example 1 of Crystalline Homopolymer)

1.0 g of n-tricosylacrylamide and 0.8 g of toluene were weighed in a 20-mL glass vessel. The glass vessel equipped with a nitrogen inlet was placed in a thermostat at 80° C., and nitrogen bubbling was continued for 10 minutes. 0.034 g of V-601 (an azo radical polymerization initiator having a 10-hour half-life temperature of 66° C., manufactured by Wako Pure Chemical Industries, Ltd.) dissolved in 0.2 g of toluene was then injected into the glass vessel to initiate radical polymerization. After six hours, the contents of the glass vessel were poured into a large amount of ethanol, and a n-tricosylacrylamide polymer was collected as a precipitate. The precipitate was dried and was crushed with fingers. The dried precipitate was easily crushed with fingers. Thus, the n-tricosylacrylamide polymer was judged to be brittle at room temperature. n-tricosylacrylamide is a crystalline acrylamide corresponding to the compound 1 in which R₁ is hydrogen and R₂ is a linear alkyl group having 23 carbon atoms (molecular weight 323).

### (Synthesis Example 2 of Crystalline Homopolymer)

A n-heptadecylacrylamide polymer was produced by replacing n-tricosylacrylamide in the “Synthesis Example 1 of Crystalline Homopolymer” with n-heptadecylacrylamide. Like the n-tricosylacrylamide polymer, the n-heptadecylacrylamide polymer was also brittle at room temperature. n-heptadecylacrylamide is a crystalline acrylamide corresponding to the compound 1 in which R₁ is hydrogen and R₂ is a linear alkyl group having 17 carbon atoms (molecular weight 239).

### (Synthesis Example 3 of Crystalline Homopolymer)

A n-pentadecylacrylamide polymer was produced by replacing n-tricosylacrylamide in the “Synthesis Example 1 of Crystalline Homopolymer” with n-pentadecylacrylamide. Like the n-tricosylacrylamide homopolymer, the n-pentadecylacrylamide polymer was also brittle at room temperature. n-pentadecylacrylamide is a crystalline acrylamide corresponding to the compound 1 in which R₁ is hydrogen and R₂ is a linear alkyl group having 15 carbon atoms (molecular weight 211).

### (Synthesis Example 4 of Crystalline Homopolymer)

A behenyl acrylate polymer was produced by replacing n-tricosylacrylamide in the “Synthesis Example 1 of Crystalline Homopolymer” with behenyl acrylate. Like the n-tricosylacrylamide polymer, the behenyl acrylate polymer was also brittle at room temperature. Behenyl acrylate has the structure of the following compound 3.

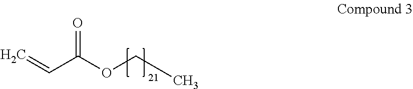

### Example 1

10.0 g of styrene and n-tricosylacrylamide in total were weighed in a 20-mL glass vessel. The glass vessel equipped with a nitrogen inlet was placed in a thermostat at 80° C., and nitrogen bubbling was continued for 10 minutes. 0.4 g of V-601 dissolved in 0.4 g of toluene was then injected into the glass vessel to initiate radical copolymerization. After five hours, 0.2 g of V-601 dissolved in 0.2 g of toluene was injected into the glass vessel, and the radical copolymerization was continued. After one hour, a solid body in the glass vessel was dried under vacuum to yield a resin composition. Styrene and n-tricosylacrylamide have monomer reactivity ratios r₁ of 2.0 and r₂ of 0.5.

Resin composition codes 1 to 11 were produced by using the following masses of styrene and n-tricosylacrylamide in the polymerization procedures described above.

### Code 1:

A resin composition produced using 9.0 g of styrene and 1.0 g of n-tricosylacrylamide (the ratio of radical polymerizable monomer having a crystalline molecular chain: 0.10)

### Code 2:

A resin composition produced using 8.0 g of styrene and 2.0 g of n-tricosylacrylamide (the ratio of radical polymerizable monomer having a crystalline molecular chain: 0.20)

### Code 3:

A resin composition produced using 7.5 g of styrene and 2.5 g of n-tricosylacrylamide (the ratio of radical polymerizable monomer having a crystalline molecular chain: 0.25)

### Code 4:

A resin composition produced using 7.0 g of styrene and 3.0 g of n-tricosylacrylamide (the ratio of radical polymerizable monomer having a crystalline molecular chain: 0.30)

### Code 5:

A resin composition produced using 6.0 g of styrene and 4.0 g of n-tricosylacrylamide (the ratio of radical polymerizable monomer having a crystalline molecular chain: 0.40)

### Code 6:

A resin composition produced using 5.0 g of styrene and 5.0 g of n-tricosylacrylamide (the ratio of radical polymerizable monomer having a crystalline molecular chain: 0.50)

### Code 7:

A resin composition produced using 4.0 g of styrene and 6.0 g of n-tricosylacrylamide (the ratio of radical polymerizable monomer having a crystalline molecular chain: 0.60)

### Code 8:

A resin composition produced using 3.0 g of styrene and 7.0 g of n-tricosylacrylamide (the ratio of radical polymerizable monomer having a crystalline molecular chain: 0.70)

### Code 9:

A resin composition produced using 2.0 g of styrene and 8.0 g of n-tricosylacrylamide (the ratio of radical polymerizable monomer having a crystalline molecular chain: 0.800)

### Code 10:

A resin composition produced using 1.5 g of styrene and 8.5 g of n-tricosylacrylamide (the ratio of radical polymerizable monomer having a crystalline molecular chain: 0.85)

### Code 11:

A resin composition produced using 1.0 g of styrene and 9.0 g of n-tricosylacrylamide (the ratio of radical polymerizable monomer having a crystalline molecular chain: 0.900)

Table shows the mass fraction of a unit derived from n-tricosylacrylamide in the resulting resin composition calculated from ¹H-NMR measurements.

Viscoelasticity was compared between the resulting resin composition and the n-tricosylacrylamide homopolymer with respect to the temperature dependence of loss modulus. In the present example, the temperature (68° C.) at which the n-tricosylacrylamide homopolymer exhibits its sharp melt property was taken as a reference temperature. The sharp melt property of the resulting resin composition was evaluated from the variation width of loss modulus between 63° C. and 73° C. The results are summarized in Table.

A phase separation structure of a styrene polymer and the n-tricosylacrylamide homopolymer was examined as described below.

A styrene polymer and the n-tricosylacrylamide homopolymer produced in the synthesis example 1 were dissolved in chloroform. Developing this solution with a large amount of methanol formed a precipitate. After the precipitate was dried under vacuum, the inner structure of the precipitate was examined. The precipitate had a phase separation structure of the styrene polymer and the n-tricosylacrylamide polymer.

The styrene polymer was produced using the following procedures. 1.0 g of styrene and 10.0 g of toluene were weighed in a 20-mL glass vessel. The glass vessel equipped with a serum cap and a nitrogen inlet was placed in a thermostat at 80° C., and nitrogen bubbling was continued for 10 minutes. 0.04 g of V-601 dissolved in 0.2 g of toluene was then injected into the glass vessel to initiate radical polymerization. After six hours, the contents of the glass vessel were poured into a large amount of methanol, and a styrene polymer was collected as a precipitate.

The resin composition codes 3 to 9 had a sea-island type phase separation structure in which the main unit of a resin component forming the island phase was a unit derived from styrene, and the main unit of a resin component forming the sea phase was a unit derived from n-tricosylacrylamide.

TABLE

| | Mass fraction of | | | Difference | |
|---|---|---|---|---|---|
| | unit derived from | Phase | | in loss | |
| | tricosylacryl- | separation | Brittle- | modulus | Sharp melt |
| Code | amide (mass %) | structure | ness | (Pa) | property |
| Code 1 | 9.6 | Not | good | 7.57 × 10⁵ | Not |
| | | observed | | | exhibited |
| Code 2 | 19.2 | Not | good | 8.28 × 10⁵ | Not |
| | | observed | | | exhibited |
| Code 3 | 26.3 | Observed | good | 1.08 × 10⁷ | Exhibited |
| | | *1) | | | |
| Code 4 | 29.3 | Observed | good | 1.45 × 10⁷ | Exhibited |
| | | *1) | | | |
| Code 5 | 41.1 | Observed | good | 1.68 × 10⁷ | Exhibited |
| | | *1) | | | |
| Code 6 | 50.7 | Observed | good | 1.67 × 10⁷ | Exhibited |
| | | *1) | | | |
| Code 7 | 59.4 | Observed | good | 1.50 × 10⁷ | Exhibited |
| | | *1) | | | |
| Code 8 | 68.9 | Observed | fair | 1.72 × 10⁷ | Exhibited |
| | | *1) | | | |
| Code 9 | 79.2 | Observed | fair | 1.62 × 10⁷ | Exhibited |
| | | *1) | | | |
| Code 10 | 83.2 | Not | poor | 1.82 × 10⁷ | Exhibited |
| | | observed | | | |
| Code 11 | 87.1 | Not | poor | 1.86 × 10⁷ | Exhibited |
| | | observed | | | |

*1) A sea-island type phase separation structure in which the main component of the island phase was a unit derived from styrene, and the main component of the sea phase was a unit derived from tricosylacrylamide.

### Example 2

6.0 g of methyl methacrylate and 4.0 g of n-tricosylacrylamide were weighed in a 20-mL glass vessel. A resin composition code 12 was produced from these monomers using the polymerization procedures described in Example 1.

The mass fraction of a unit derived from n-tricosylacrylamide in the code 12 was 38.4 mass % when calculated from ¹H-NMR measurements.

The inner structure of the code 12 was examined. The code 12 had a sea-island type phase separation structure in which the main unit of a resin component forming the island phase was a unit derived from methyl methacrylate, and the main unit of a resin component forming the sea phase was a unit derived from n-tricosylacrylamide.

In the evaluation of brittleness, the code 12 was rated good. In the evaluation of resin viscoelasticity, the code 12 had substantially the same sharp melt property as the code 5.

Methyl methacrylate and n-tricosylacrylamide have monomer reactivity ratios r₁ of 4.0 and r₂ of 0.4.

A phase separation structure of a methyl methacrylate polymer and the n-tricosylacrylamide homopolymer was examined as described below.

A methyl methacrylate polymer and the n-tricosylacrylamide homopolymer produced in the synthesis example 1 were dissolved in chloroform. Developing this solution with a large amount of methanol formed a precipitate. After the precipitate was dried under vacuum, the inner structure of the precipitate was examined. The precipitate had a sea-island type phase separation structure in which the main unit of a resin component forming the island phase was a unit derived from methyl methacrylate, and the main unit of a resin component forming the sea phase was a unit derived from n-tricosylacrylamide.

The methyl methacrylate polymer was produced using the following procedures. 1.0 g of methyl methacrylate and 10.0 g of toluene were weighed in a 20-mL glass vessel. The glass vessel equipped with a serum cap and a nitrogen inlet was placed in a thermostat at 80° C., and nitrogen bubbling was continued for 10 minutes. 0.04 g of V-601 dissolved in 0.2 g of toluene was then injected into the glass vessel to initiate radical polymerization. After six hours, the contents of the glass vessel were poured into a large amount of methanol, and a methyl methacrylate polymer was collected as a precipitate.

### Example 3

6.0 g of styrene and 4.0 g of n-tricosylacrylamide were weighed in a 20-mL glass vessel. The glass vessel equipped with a nitrogen inlet was placed in a thermostat at 70° C., and nitrogen bubbling was continued for 10 minutes. 0.4 g of V-65 (an azo radical polymerization initiator having a 10-hour half-life temperature of 51° C., manufactured by Wako Pure Chemical Industries, Ltd.) and 0.4 g of V-601 dissolved in 0.8 g of toluene were then injected into the glass vessel to initiate radical copolymerization. After five hours, the set temperature of the thermostat was increased to 80° C., and the radical copolymerization was continued. After two hours, a solid body in the glass vessel was dried under vacuum to yield a resin composition code 13.

The mass fraction of a unit derived from n-tricosylacrylamide in the code 13 was 37.0 mass % when calculated from ¹H-NMR measurements.

The inner structure of the code 13 was examined. The code 13 had a sea-island type phase separation structure in which the main unit of a resin component forming the island phase was a unit derived from styrene, and the main unit of a resin component forming the sea phase was a unit derived from n-tricosylacrylamide.

In the evaluation of brittleness, the code 13 was rated good. In the evaluation of resin viscoelasticity, the code 13 had substantially the same sharp melt property as the code 5.

A phase separation structure of a styrene polymer and the n-tricosylacrylamide homopolymer was examined as described below.

A styrene polymer and the n-tricosylacrylamide homopolymer produced in the synthesis example 1 were dissolved in chloroform. Developing this solution with a large amount of methanol formed a precipitate. After the precipitate was dried under vacuum, the inner structure of the precipitate was examined. The precipitate had a sea-island type phase separation structure in which the main unit of a resin component forming the island phase was a unit derived from styrene, and the main unit of a resin component forming the sea phase was a unit derived from n-tricosylacrylamide.

The styrene polymer was produced using the following procedures. 1.0 g of styrene and 10.0 g of toluene were weighed in a 20-mL glass vessel. The glass vessel equipped with a serum cap and a nitrogen inlet was placed in a thermostat at 80° C., and nitrogen bubbling was continued for 10 minutes. 0.04 g of V-601 dissolved in 0.2 g of toluene was then injected into the glass vessel to initiate radical polymerization. After six hours, the contents of the glass vessel were poured into a large amount of methanol, and a styrene polymer was collected as a precipitate.

### Example 4

6.0 g of styrene and 4.0 g of n-heptadecylacrylamide were weighed in a 20-mL glass vessel. A resin composition code 14 was produced using the polymerization procedures described in Example 3. The mass fraction of a unit derived from n-heptadecylacrylamide in the code 14 was 40.4 mass % when calculated from ¹H-NMR measurements. The inner structure of the code 14 was examined. The code 14 had a sea-island type phase separation structure in which the main unit of a resin component forming the island phase was a unit derived from styrene, and the main unit of a resin component forming the sea phase was a unit derived from n-heptadecylacrylamide.

In the evaluation of brittleness, the code 14 was rated good. In the evaluation of the resin viscoelasticity of the code 14 and the n-heptadecylacrylamide polymer, the temperature dependence of loss modulus was compared. The code 14 had substantially the same sharp melt property as the n-heptadecylacrylamide polymer. The starting temperature of the sharp melt of the code 14 and the temperature at which the n-heptadecylacrylamide polymer exhibited the sharp melt property were 37° C.

Styrene and n-heptadecylacrylamide have monomer reactivity ratios r₁ of 2.0 and r₂ of 0.5.

A phase separation structure of a styrene polymer and the n-heptadecylacrylamide homopolymer was examined as described below.

A styrene polymer and the n-heptadecylacrylamide homopolymer produced in the synthesis example 2 were dissolved in chloroform. Developing this solution with a large amount of methanol formed a precipitate. After the precipitate was dried under vacuum, the inner structure of the precipitate was examined. The precipitate had a sea-island type phase separation structure in which the main unit of a resin component forming the island phase was a unit derived from styrene, and the main unit of a resin component forming the sea phase was a unit derived from n-heptadecylacrylamide.

The styrene polymer was produced using the following procedures. 1.0 g of styrene and 10.0 g of toluene were weighed in a 20-mL glass vessel. The glass vessel equipped with a serum cap and a nitrogen inlet was placed in a thermostat at 80° C., and nitrogen bubbling was continued for 10 minutes. 0.04 g of V-601 dissolved in 0.2 g of toluene was then injected into the glass vessel to initiate radical polymerization. After six hours, the contents of the glass vessel were poured into a large amount of methanol, and a styrene polymer was collected as a precipitate.

### Comparative Example 1

6.0 g of styrene and 4.0 g of n-pentadecylacrylamide were weighed in a 20-mL glass vessel. The glass vessel equipped with a nitrogen inlet was placed in a thermostat at 80° C., and nitrogen bubbling was continued for 10 minutes. 1.0 g of V-601 dissolved in 0.8 g of toluene was then injected into the glass vessel to initiate radical copolymerization. After five hours, 1.0 g of V-601 dissolved in 0.8 g of toluene was injected into the glass vessel, and the radical copolymerization was continued. After one hour, a solid body in the glass vessel was dried under vacuum to yield a resin composition ref 1. The mass fraction of a unit derived from n-pentadecylacrylamide in the ref 1 was 39.8 mass % when calculated from ¹H-NMR measurements.

The inner structure of the ref 1 was examined. No phase separation structure was observed.

In the evaluation of brittleness, the ref 1 was rated good.

In the evaluation of the resin viscoelasticity of the ref 1 and the n-pentadecylacrylamide polymer, the temperature dependence of loss modulus was compared. The temperature at which the n-pentadecylacrylamide polymer exhibited the sharp melt property was 20° C. The ref 1 had no sharp melt property, and the loss modulus of the ref 1 decreased gradually with the temperature. Styrene and n-pentadecylacrylamide have monomer reactivity ratios r₁ of 2.0 and r₂ of 0.5.

A phase separation structure of a styrene polymer and the n-pentadecylacrylamide homopolymer was examined as described below.

A styrene polymer and the n-pentadecylacrylamide homopolymer produced in the synthesis example 3 were dissolved in chloroform. Developing this solution with a large amount of methanol formed a precipitate. After the precipitate was dried under vacuum, the inner structure of the precipitate was examined. No phase separation structure was observed.

The styrene polymer was produced using the following procedures. 1.0 g of styrene and 10.0 g of toluene were weighed in a 20-mL glass vessel. The glass vessel equipped with a serum cap and a nitrogen inlet was placed in a thermostat at 80° C., and nitrogen bubbling was continued for 10 minutes. 0.04 g of V-601 dissolved in 0.2 g of toluene was then injected into the glass vessel to initiate radical polymerization. After six hours, the contents of the glass vessel were poured into a large amount of methanol, and a styrene polymer was collected as a precipitate.

### Comparative Example 2

6.0 g of styrene and 4.0 g of behenyl acrylate were weighed in a 20-mL glass vessel. A resin composition ref 2 was produced using the polymerization procedures described in Example 1.

The mass fraction of a unit derived from behenyl acrylate in the ref 2 was 40.2 mass % when calculated from ¹H-NMR measurements.

The inner structure of the ref 2 was examined. No phase separation structure was observed.

In the evaluation of brittleness, the ref 2 was rated good.

In the evaluation of the resin viscoelasticity of the ref 2 and the behenyl acrylate polymer, the temperature dependence of loss modulus was compared. The temperature at which the behenyl acrylate polymer exhibited the sharp melt property was 63° C. The ref 2 had no sharp melt property, and the loss modulus of the ref 1 decreased gradually with the temperature. Styrene and behenyl acrylate have monomer reactivity ratios r₁ of 0.8 and r₂ of 0.3.

A phase separation structure of a styrene polymer and the behenyl acrylate homopolymer was examined as described below.

A styrene polymer and the behenyl acrylate homopolymer produced in the synthesis example 4 were dissolved in chloroform. Developing this solution with a large amount of methanol formed a precipitate. After the precipitate was dried under vacuum, the inner structure of the precipitate was examined. No phase separation structure was observed.

The styrene polymer was produced using the following procedures. 1.0 g of styrene and 10.0 g of toluene were weighed in a 20-mL glass vessel. The glass vessel equipped with a serum cap and a nitrogen inlet was placed in a thermostat at 80° C., and nitrogen bubbling was continued for 10 minutes. 0.04 g of V-601 dissolved in 0.2 g of toluene was then injected into the glass vessel to initiate radical polymerization. After six hours, the contents of the glass vessel were poured into a large amount of methanol, and a styrene polymer was collected as a precipitate.

The present invention can provide a method for producing a resin composition that has a sharp melt property and has toughness at room temperature in a single production process.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-093538, filed Apr. 26, 2013 which is hereby incorporated by reference herein in its entirety.

What is claimed is:

1. A method for producing a resin composition, comprising the step of:
subjecting a radical copolymerization of
a first radical polymerizable monomer which is free from any crystalline molecular chain, and
a second radical polymerizable monomer having a crystalline molecular chain, in the presence of a radical polymerization initiator,
wherein the second radical polymerizable monomer is the following compound 1, 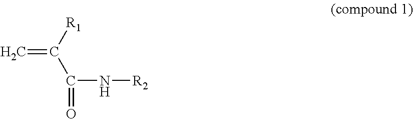
(wherein R₁ denotes a hydrogen atom or a methyl group, and R₂ denotes an alkyl group having at least 17 carbon atoms) the first radical polymerizable monomer and the second radical polymerizable monomer are a combination of monomers such that a precipitate, which is obtained by a method shown below, has a phase separation structure,
the method comprising the steps of:
preparing a first homopolymer by polymerizing the first radical polymerizable monomer,
preparing a second homopolymer by polymerizing the second radical polymerizable monomer,
dissolving the first homopolymer and the second homopolymer in a solvent and obtaining a solution of the homopolymers, and
adding the solution of the homopolymers to a common poor solvent and obtaining the precipitate,
the first radical polymerizable monomer has the following monomer reactivity ratio r₁, and the second radical polymerizable monomer has the following monomer reactivity ratio r₂, and
r₁>1.0
r₂<1.0
(wherein r₁=k₁₁/k₁₂,
wherein k₁₁ denotes a reaction rate constant of an addition reaction in which the first radical polymerizable monomer binds to the first radical polymerizable monomer, and
k₁₂ denotes a reaction rate constant of an addition reaction in which the second radical polymerizable monomer binds to the first radical polymerizable monomer, and
r₂=k₂₂/k₂₁,
wherein k₂₂ denotes a reaction rate constant of an addition reaction in which the second radical polymerizable monomer binds to the second radical polymerizable monomer, and
k₂₁ denotes a reaction rate constant of an addition reaction in which the first radical polymerizable monomer binds to the second radical polymerizable monomer)
the ratio (B/(A+B)) of the second radical polymerizable monomer to the first radical polymerizable monomer is 0.25 or more and 0.80 or less in the copolymerization, wherein A denotes the amount of first radical polymerizable monomer (parts by mass), and B denotes the amount of second radical polymerizable monomer (parts by mass).

2. The method for producing a resin composition according to claim 1, wherein R₂ in the compound 1 is a linear alkyl group.

3. The method for producing a resin composition according to claim 1, wherein the ratio (B/(A+B)) of the second radical polymerizable monomer to the first radical polymerizable monomer in the copolymerization is 0.30 or more and 0.60 or less.

4. The method for producing a resin composition according to claim 1, wherein the radical polymerization initiator includes two or more radical polymerization initiators having different 10-hour half-life temperatures that differ by 10° C. or more.

5. The method for producing a resin composition according to claim 1, wherein the phase separation structure is a sea-island type phase separation structure.

6. A resin composition, comprising a first unit which is free from any crystalline molecular chain and a second unit having a crystalline molecular chain, wherein
the second unit having a crystalline molecular chain is the following unit 1, 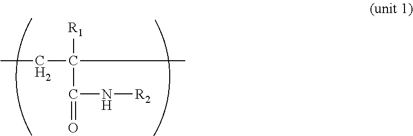
(wherein R₁ denotes a hydrogen atom or a methyl group, and R₂ denotes an alkyl group having at least 17 carbon atoms)
the ratio (D/(C+D)) of the second unit to the first unit is 0.25 or more and 0.80 or less in the resin composition, wherein C denotes the amount of first unit (parts by mass), and D denotes the amount of second unit (parts by mass), and the resin composition has a sea-island type phase separation structure in which a main unit of a resin component forming the island phase is the first unit, and a main unit of a resin component forming the sea phase is the second unit.

7. The resin composition according to claim 6, wherein the ratio (D/(C+D)) of the unit having a crystalline molecular chain to the first unit in the resin composition is 0.30 or more and 0.60 or less.
